(19) United States
(12) Patent Application Publication
(10) Pub. No.: US 2008/0288329 A1
(43) Pub. Date: Nov. 20, 2008

(54) User interface for identifying trade opportunities

(75) Inventors: Peter Nannis, Dana Point, CA (US); Charles Cochran, Wichita, KS (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: Investors Inside Edge LLC, Chicago, IL (US)

(21) Appl. No.: 12/082,062

(22) Filed: Apr. 8, 2008

Related U.S. Application Data
(60) Provisional application No. 60/938,350, filed on May 16, 2007.

(51) Int. Cl. G06Q 30/00

(52) U.S. Cl. 705/10

(57) ABSTRACT

A computerized trading system is provided including a streamlined trading user interface for analyzing market trends and identifying trade opportunities. In an embodiment, the trading user interface includes a plurality of streamlined user interface screens that sequence the flow of market information from analyzing market data and arriving at a buy/sell decision, to executing the trade. Once a trader arrives at a buy/sell decision, the trading interface combines all the information necessary for trade execution, management and exit onto one screen so as to avoid the necessity to scroll back through multiple screens/windows to extract or check for information. Preferably, the trading interface employs color coding to provide an at-a-glance summary of market conditions, thereby minimizing the analysis effort and reducing the intense focus on screen activity. The trading interface further includes a plurality of real-time market edge indicators for identifying a potential trade opportunity.

### CROSS-REFERENCE TO RELATED APPLICATIONS

This patent application claims the benefit of U.S. Provisional Patent Application No. 60/938,350 which was filed May 16, 2007, which is incorporated herein in its entirety.

### FIELD OF THE INVENTION

This invention relates generally to the field of computer-based financial trading and more specifically to the area of trading of commodities and financial instruments via an electronic exchange.

### BACKGROUND OF THE INVENTION

As part of a trade planning and execution, a market trader generally looks at a chart of the price action to gain historical insight of the market activity and then makes inferences as to what is likely to happen in the future. This type of chart interpretation and study is commonly referred to as technical analysis. Conducting technical analysis typically takes a large amount of time, and may be performed via a user interface of a computing device displaying the appropriate data. The average trader spends a good deal of time conducting technical analysis. After or during the analysis stage, the trader may wish to place a trade as a result of the analysis. Typically, the trader will need to reference a different user interface in order to place such a trade, resulting in screen clutter, inefficiency, and potential confusion. To gain a complete understanding of the market direction and to identify a market trend prior to placing a trade, the trader typically needs to analyze both long-term and short-term market data, which may require the trader to consult multiple analysis screens, thereby further increasing the analysis effort.

The historical data may be presented via a long-term historical chart, but an alternative data presentation is a depth of market tabular representation. This interface as well can create certain inefficiencies and confusion depending upon the way in which the presented information is managed and arranged.

### BRIEF SUMMARY OF THE INVENTION

Embodiments of the invention are used to provide a computerized trading system including a streamlined trading user interface for analyzing market trends and identifying trade opportunities. In an embodiment, the trading user interface includes a plurality of streamlined user interface screens that sequence the flow of market information from analyzing market data and arriving at a buy/sell decision, to executing the trade. Once a trader arrives at a buy/sell decision, the trading interface combines all the information necessary for trade execution, management and exit onto one screen so as to avoid the necessity to scroll back through multiple screens/windows to extract or check for information. Preferably, the trading interface employs color coding to provide an at-a-glance summary of market conditions, thereby minimizing the analysis effort and reducing the intense focus on screen activity. The trading interface further includes a plurality of real-time market edge indicators for identifying a potential trade opportunity.

In one aspect of the invention, a computer system is provided for identifying trade opportunities, the system comprising a server for collecting and storing market data for a plurality of financial instruments, a user interface for displaying the market data received from the server to facilitate analysis and trade execution by a financial trader, the user interface comprising (a) a plurality of screens, each screen configured to display the market data along one of sequentially decreasing time axes, (b) a plurality of vertically oriented price and volume distributions individually configurable by the financial trader to define a plurality of market profile splits, each market profile split comprising a plurality of timeframes corresponding to one of the sequentially decreasing time axes, (c) a vertically oriented long-term volume distribution comprising volume and price information for at least one year, (d) an equivolume bar chart configured to display short-term price and volume information, and (e) a plurality of market edge indicators for signaling changes in a trend of the market data, at least one of the market edge indicators corresponding to a potential trade opportunity.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

While the appended claims set forth the features of the present invention with particularity, the invention and its advantages are best understood from the following detailed description taken in conjunction with the accompanying drawings, of which:

FIG. 1 is a diagram illustrating an implementation of a system representing a computerized trading system including a streamlined user interface for analyzing market trends and identifying trade opportunities, as contemplated by an embodiment of the present invention;

FIG. 2 is a diagram illustrating a monthly market profile screen of the trading user interface of FIG. 1, as contemplated by an embodiment of the present invention;

FIG. 3 is a diagram illustrating a thirty minute profile screen of the trading interface of FIG. 1, in accordance with an embodiment of the invention;

FIGS. 4A and 4B are diagrams illustrating an interface screen of the user interface of FIG. 1 comprising a color-coded thirty minute bar chart with day volume information vertically disposed along the side of the screen, in accordance with an embodiment of the invention;

FIGS. 5A and 5B are diagrams illustrating interface screens of the user interface of FIG. 1, including an equivolume bar chart and a plurality of real-time market edge indicators, in accordance with an embodiment of the invention; and

FIG. 6 is a diagram illustrating trader a market edge parameter screen of the user interface of FIG. 1 for receiving user defined parameters for generation of real-time market edge indicators of FIG. 5, in accordance with an embodiment of the invention.

### DETAILED DESCRIPTION OF THE INVENTION

The following examples further illustrate the invention but, of course, should not be construed as in any way limiting its scope.

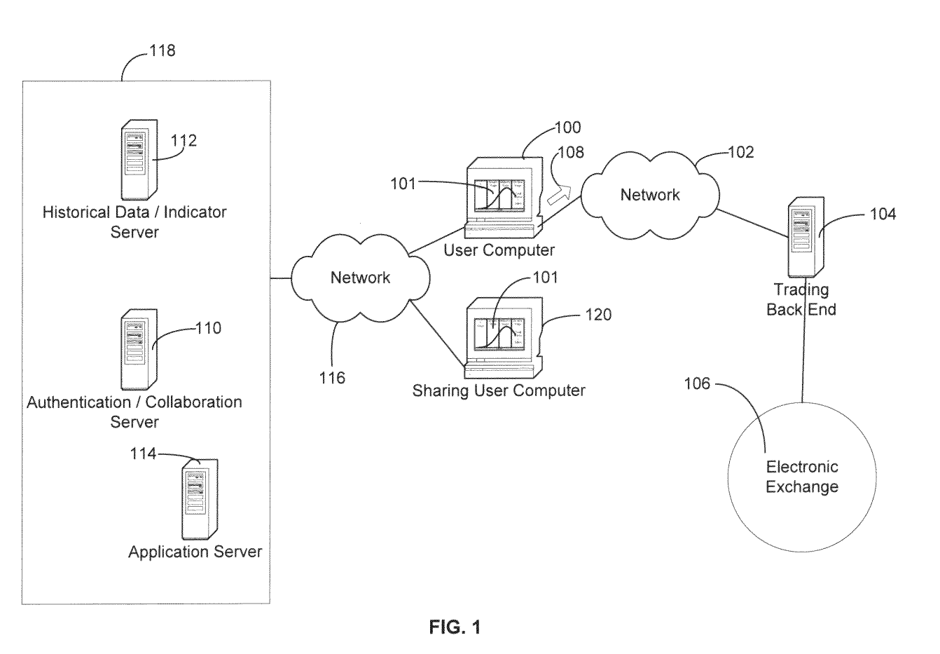

Turning to FIG. 1, an implementation of a system contemplated by an embodiment of the invention is shown with respect to a computerized trading system including a streamlined user interface for analyzing market trends and identifying trade opportunities.

The system according to embodiments of the invention operates in a network environment such as, but not limited to, the environment shown in FIG. 1. A user computer 100 connects via any suitable network 102 (e.g., Internet and/or WAN, LAN) to a trading backend 104. The trading back end 104, in turn, is connected to a financial electronic exchange 106. In operation, the user computer 100 interfaces with the backend 104 via a network 102 to execute computer readable trading instructions 108 on an electronic exchange 106. The user computer 100 stores computer executable instructions for presenting the user with a trading user interface 101 for analyzing real-time and historical market data and initiating trade orders via trading instructions 108. Real-time and historical market data comprises price, time, trading volume, index values, as well as other information typically collected from the electronic exchange 106 for a plurality of financial instruments, commodities, and financial indexes. Preferably, the financial instruments include futures contracts, such as e-Mini, S&P, and U.S. Treasury Bond futures. In embodiments, the financial instruments further include stocks, bonds, cash, cash equivalents, and options, among other instruments.

The user computer 100 also interfaces with a plurality of servers 110-114 via a network 116, such as a LAN, WAN, or the Internet. In an embodiment, the servers 110-114 are hosted by a data center 118. The user computer 100 interfaces with an authentication collaboration/educator server 110 via the network 116. The server 110 acts to authorize the user to operate all or some of the software features on the user computer 100, and supplies the setting, configuration or other information to the user computer 100. In addition, server 110 assists collaboration of the user with other users. For example, in an embodiment of the invention, the software executing the invention supports a collaboration mode whereby a user of the user computer 100 shares information with and receives information from another user of the trading interface 101. In this case, the user computer 100 is connected via the network 116 to another user computer 120 via server 110. Although this description speaks of certain machines performing certain functions, it will be appreciated that, for example, the functions of authentication, collaboration support, and education may be served by one server or multiple servers depending upon designer preferences.

In an embodiment of the invention, computer 100 is also linked via the network 116 to a historical data/indicator server 112 for collecting and storing market data for a plurality of financial instruments, commodities, and financial indexes from the electronic exchange 106. As will be appreciated by those of skill in the art, a third party source of market information may be used to provide current (e.g., real-time) and historical market data. In such an embodiment, the user's computer interfaces with a third party source of market data electronically via the network 116. In yet another embodiment, the system includes an application server 114 for hosting some or all of the functionality of the trading interface 101, such as via an Active Server Pages (ASP) arrangement.

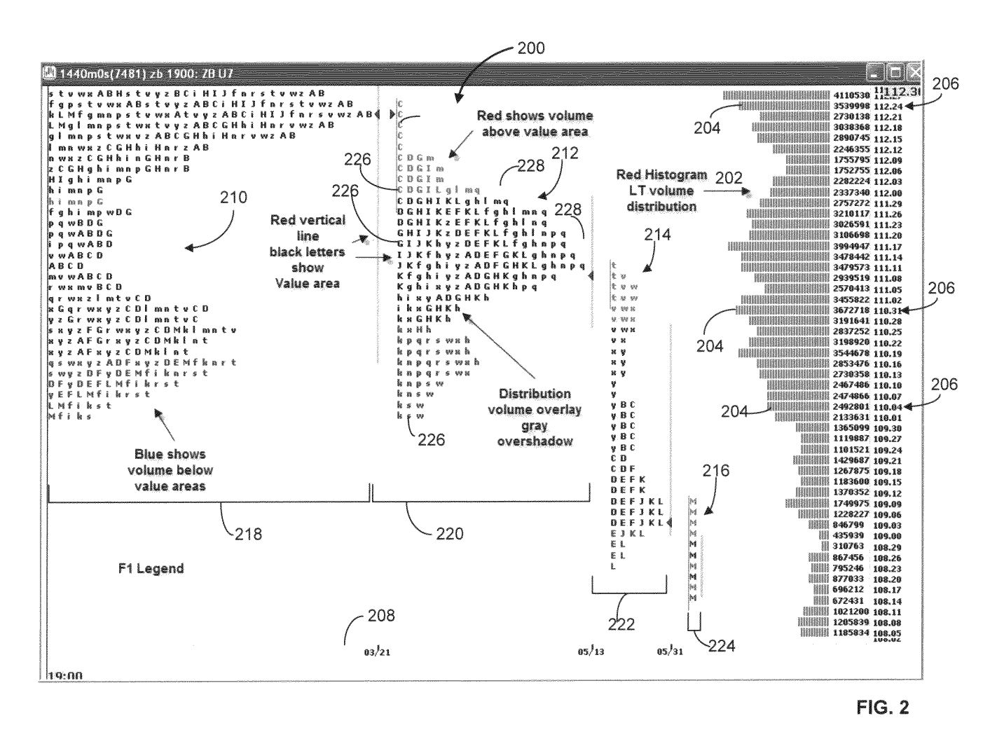

In FIGS. 2-5B, an embodiment of the trading user interface 101 is shown in more detail with respect to a plurality of streamlined user interface screens that sequence the flow of market information from analyzing market data and arriving at a buy/sell decision, to executing the trade. Once a trader arrives at a buy/sell decision, the trading interface 101 combines all the information necessary for trade execution, management and exit onto one screen so as to avoid the necessity to scroll back through multiple screens/windows to extract or check for information. Preferably, the trading interface 101 employs color coding to provide an at-a-glance summary of market conditions, thereby minimizing the analysis effort and reducing the intense focus on screen activity. The trading interface 101 also includes a plurality of real-time market edge indicators for identifying a potential trade opportunity.

Turning to FIG. 2, an embodiment of a monthly market profile screen 200 of the trading user interface 101 is shown. The long term volume distribution area 202 comprises a volume histogram of trading activity for a plurality of years in order to capture consensus price ranges (areas) of market value. Preferably, the long term volume distribution area 202 is vertically oriented along a side of the screen 200 and is capable of representing multiple years worth of volume data. The long term volume distribution area 202 is based on actual tick-by-tick data. The trading interface 101 accepts user input to control the span of time included in the long term volume distribution area 202. The volume data represents trading volume of a financial instrument, such as a futures contract. In one embodiment, each of the histogram bars 204 is color-coded to represent the number of contracts traded per transaction, thereby allowing the trader to differentiate between small and large trades (e.g., trades initiated by small market speculators versus large institutional trades), such as by showing different color-coded lot sizes within each volume bar 204. Each of the volume bars 204 corresponds to a numerical volume/price pair 206 representing the trading volume at a particular price point. In an embodiment, the volume distribution 202 is also be broken down into buyers and sellers (i.e., trades at bid/ask).

The screen 200 further includes a horizontally disposed monthly timeline axis 208 that represents trading activity for a plurality of months. The monthly timeframe of the axis 208 allows the trader to analyze historical, current, and future price and volume data within a plurality of near past and near future timeframes, while the vertically disposed long term volume distribution area 202 provides the trader with an overall long term market perspective. In one embodiment, the length of the long term volume distribution area 202 is tied to the span of time represented by the monthly timeline axis 208. For example, when the monthly timeline axis 208 is set to 360 days (12 months), the long term volume distribution 202 represents volume activity for a corresponding time period.

To analyze the daily, weekly, and monthly market profiles for a given financial instrument, the monthly market profile screen 200 is capable of displaying a plurality of monthly price/volume profile distributions 210-216 corresponding to user-defined timeframes 218-224 along the monthly time axis 208. Preferably, the monthly market profile screen 200 responds to user input (e.g., mouse clicks along the monthly time axis 208 or data input via a keyboard or a submenu) for splitting the monthly time axis 208 into a plurality of timeframes 218-224 ranging from one or more days to multiple months. Preferably, the user input for splitting the time axis 208 is a single action input, such as a single mouse click, a keyboard key selection (e.g., a function key), or the like. Similarly, a user supplies a single action input (e.g., a single mouse click on the price/volume distribution 210-216 or selection of another function key) for folding one or more price/volume distributions 210-216 back into an immediately prior distribution.

In one embodiment, monthly profile distributions 210-216 comprise a color-coded graphical representation of daily price ranges of trading within, below, and above the financial instruments' future price value range, where each alphabetical character 226 represents a single day's price range. For example, black daily price range characters 226 represent trading within the value area of the financial instrument, while blue and red daily price range characters 226 represent price ranges below and above the value area, respectively. The value area comprises all price levels included in one standard deviation of the total volume in the time period counted from the volume weighted mean of a given distribution.

In another embodiment, the monthly profile distributions 210-216 comprise different line patterns to graphically represent trading within, below, and above the value area. In the illustrated embodiment, the daily price range characters 226 are overlaid by a corresponding monthly volume histogram 228 representing the trading volume for the corresponding timeframe 218-224. The monthly volume histogram 228 is scaled by allowing the largest volume bar to scale to the longest line of letters to enhance the trader's ability to identify volume/price skewing. Once the trader finds the appropriate market profile split by defining the desired timeframe 218-224, the trader is able to save the corresponding monthly price/volume profile distributions 210-216 and corresponding monthly volume histograms 228 for future reference and/or additional analysis, thereby saving significant analysis time in the future.

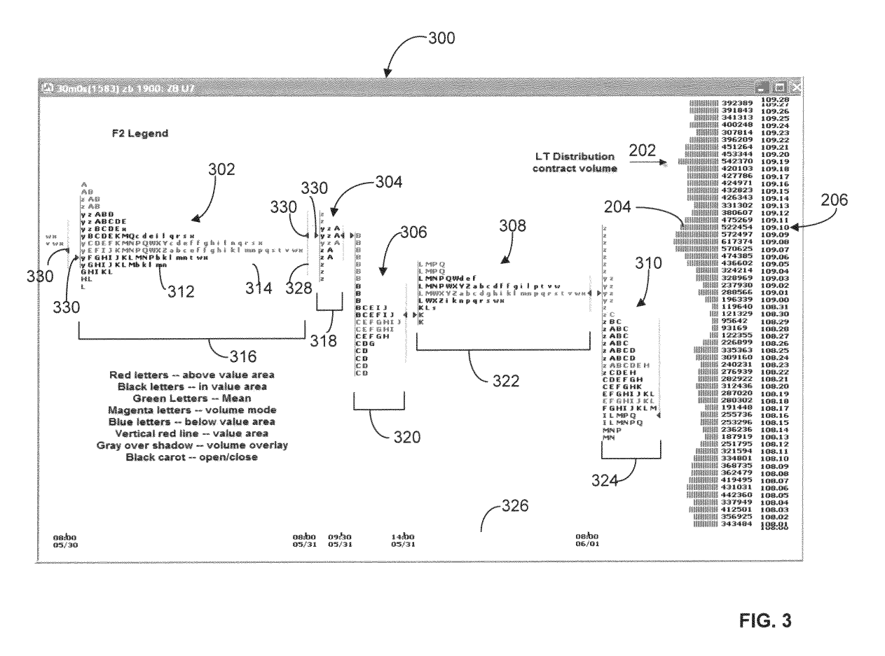

Turning to FIG. 3, an embodiment of a thirty minute profile screen 300 of the trading interface 101 is shown. The thirty minute profile screen 300 provides daily market profiles by displaying vertically disposed daily price/volume profile distributions 302-310, along with the vertically disposed long term volume distribution area 202. Each graphical data point, such as a character 312, within a daily price/volume profile distribution 302-310 represents a thirty minute price range. In an embodiment, the trading interface 101 accepts user input for specifying additional time increments associated with price ranges represented by each graphical data point 312. Preferably, the characters 312 are overlaid by a corresponding volume histogram 314 representing the trading volume for the corresponding timeframes 316-324 along the time axis 326. Alternatively, the volume histogram 314 may be presented at the side of each distribution 302-310. In the illustrated embodiment, the thirty minute price points 312 are color-coded to represent prices within, above, and below the financial instrument's value area, as well as to represent a volume weighted mean and volume mode for each daily profile distribution. Vertical lines 328 also provide a graphical indication of the value area, while indicators 330 point to the price and volume information corresponding to a market open and market close within each timeframe 316-324. The trading interface 101 accepts user input for defining and saving custom timeframes 316-324 along the thirty minute time axis 326 to speed up future analysis and setup process.

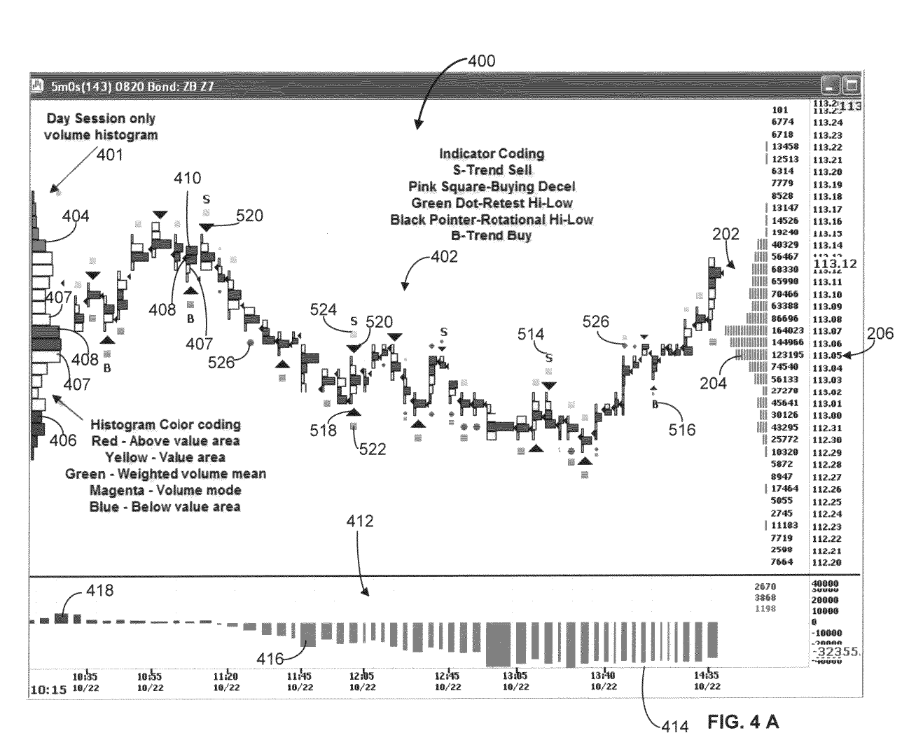

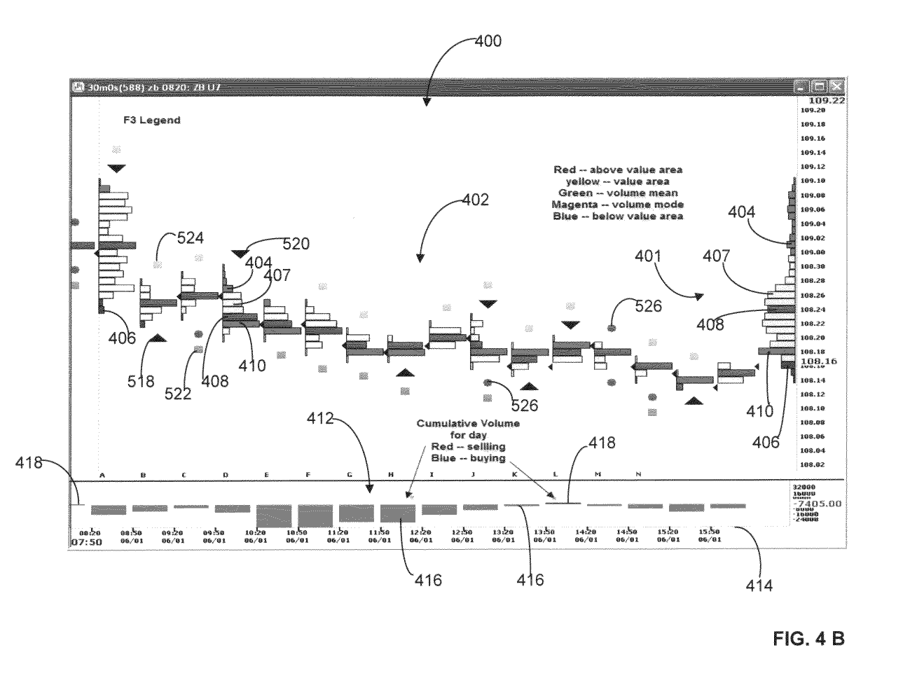

As illustrated in FIG. 4A, to provide market activity detail within a single day, the trading interface 101 includes a screen 400 comprising a color-coded thirty minute bar chart 402 with day volume information 401 vertically disposed along one side of the screen 400 and long-term volume distribution 202 vertically disposed along the opposite side of the screen 400 to allow a quick comparison of the daily activity with the long-term price/volume distribution. The trading interface 101 optionally accepts user input for omitting the vertically disposed display of the long term volume distribution 202, such as to increase legibility of the screen 400 (FIG. 4B). In the illustrated embodiments of FIGS. 4A and 4B, red price levels 404 of the thirty minute bar chart 402 represent prices above the value area, while blue price levels 406 represent prices below the value area. Correspondingly, yellow price levels 407 represent prices within the value area. Green price levels 408 represent the weighted mean of the volume, while magenta price levels 410 represent the actual high volume number of the period when it is different from the mean (i.e., a volume mode). In embodiments, the bar chart 402 graphically represents changes in volume, time, price, or ticks (trades). The volume distribution 401 represents volume activity for the entire day with the same color scheme as the bar chart 402, thereby showing the most recent activity and closest relevant price points where the trader should expect either an opposite market activity or a pause. The information presented via the screen 400 keeps the trader closest to the market profile information that drives the activity of the traditional market profile user.

To indicate buying and selling activity for the selected day, the cumulative trading volume histogram 412 is horizontally disposed along the bottom of the screen 400. The cumulative trading volume histogram 412 shows cumulative color-coded differential buying and selling activity for the day in thirty minute increments along the time axis 414. Red colored volume bars 416 represent the selling activity, while blue colored bars 418 indicate buying within a given thirty minute segment.

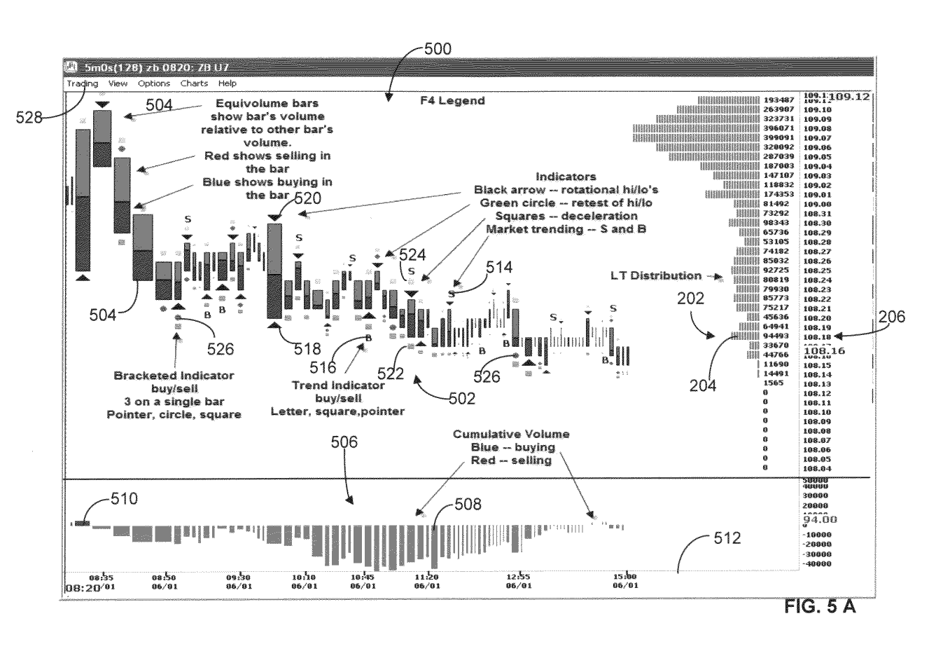

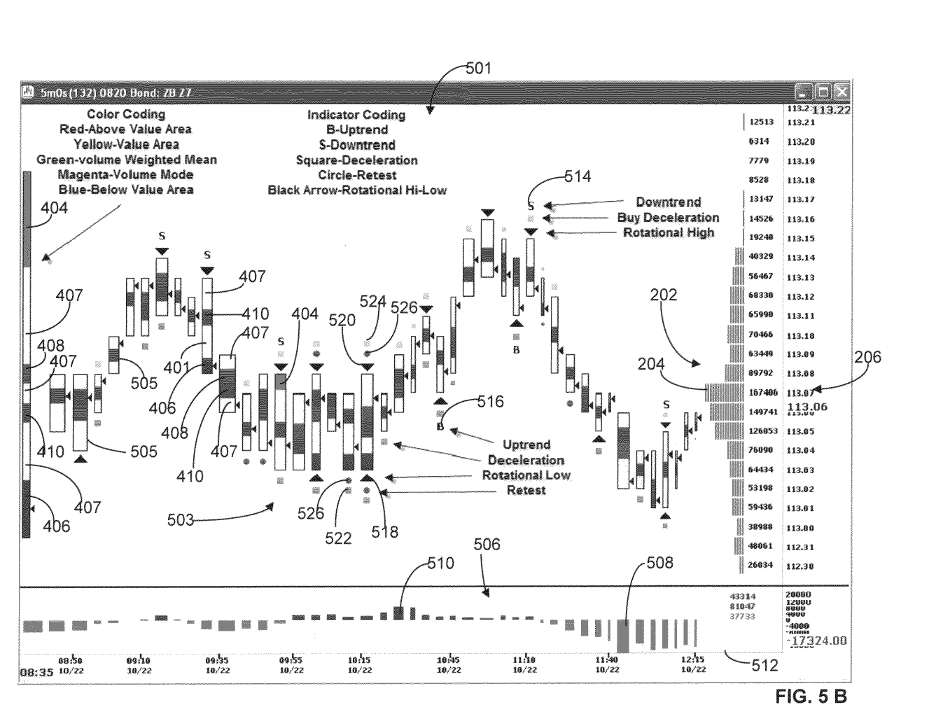

Turning to FIG. 5A, an embodiment of a trade setup and execution screen 500 is shown, including an equivolume bar chart and a plurality of real-time alert indicators. Preferably, the trade setup and execution screen 500 combines all relevant information and trading functionality on a single screen necessary to execute, monitor, or exit a trade. The five minute equivolume bar chart 502 shows volume information represented by a given bar 504 relative to the volume represented by other bars in the chart via the width of each individual bar 504 along the horizontal axis, while showing the price information via the height of each individual bar 504 along the vertical axis. The equivolume bar width is calculated as the actual volume for each bar 504 in relation to the average volume of the other bars shown on the chart 502 to maintain a proportional scaling across the chart. Wider bars 504 have greater volume. Each bar 504 is color-coded to show volume corresponding to the offer (e.g., in red) and bid (e.g., in blue) to allow the trader to track the side of the market getting the most volume in any bar. This provides the trader with a quick update on the current buying and selling situation. In an embodiment of FIG. 5B, prior to proceeding to the trade setup and execution screen 500 (FIG. 5A), the trader is presented with an interface screen 501 having a five minute equivolume bar chart 503 wherein the equivolume bars 505 are color-coded to show pricing above the value area (e.g., red bars 404), at the value area (e.g., yellow bars 407), below the value area (e.g., blue bars 406), as well as volume mode and weighted mean of the volume (e.g., green bars 408 and magenta bars 410, respectively).

Referring to FIGS. 5A and 5B, to help track the high and low volume numbers affecting the trade, the interface screens 500, 501 further comprise a vertically disposed long term volume distribution area 202 along the side of the screen 500, 501 including numerical volume/price pairs 206 representing the trading volume at a particular price point and corresponding to each of the volume bars 204. A cumulative volume histogram 506 is horizontally disposed at the bottom of the screen 500, 501 to track the cumulative buying and selling for the current day. The cumulative volume histogram 506 is color coded to represent buying and selling trends. For example, red volume bars 508 represent selling, while blue volume bars 510 represent buying. Furthermore, red volume bars 508 indicating a selling trend are oriented toward the bottom of the screen 500, while blue volume bars 510 indicating a buying trend are oriented toward the top of the screen 500, thereby providing a quick indication of the overall buying or selling pressure in the market. Therefore, the bars 508, 510 show the cumulative delta of buying/selling within a given time frame. Greater numbers of buying or selling volume bars 508, 510 indicate an overall buying or selling trend. A time axis 512 provides a time reference for the equivolume chart 502 and cumulative volume histogram 506.

To provide indications of potential trade opportunities, the five minute equivolume bar chart 502, 503, as well as the thirty minute bar chart 402 of the screen 400 (FIG. 4), further includes a plurality of real-time market edge indicators 514-526 that capture the trade setup—a phenomenon that triggers a trade and entry. In the illustrated embodiment, trending indicators 514, 516 show whether the market is trending, such as via characters “S” (selling) and “B” (buying) disposed above and below corresponding equivolume bars 504 to represent selling and buying trends for the timeframe along the time axis 512 corresponding to a given equivolume bar 504, 505. To speed up the analysis of real-time and historical data, the up and down indicators 518, 520 isolate and show each rotational high (518) and low (520) for a given equivolume bar 504, 505 and its associated timeframe. In the illustrated embodiment, the rotational high and low indicators 518, 520 comprise up and down arrows respectively. A price rotation is determined from a predetermined number of sequential bars with higher highs or lower lows before a lower high or higher low is encountered. This can be overridden by a new sequential bar with a higher high or lower low as referenced by the last rotational high/low. The square indicators 522, 524 show potential turning points or edges in the market by measuring the deceleration in market activity over the number of selected price increments; the shorter the timeframe, the fewer the price increments. In one embodiment, the equivolume bar charts 502, 503 further include acceleration indicators. Acceleration/deceleration is determined from ratios between price changes and volume or ticks at sequential price levels from the high/low of the bar. Specifically, deceleration indicates a decrease, while acceleration indicates an increase in the price/volume ratio. Finally, the circle indicator 526, disposed either above or below a given equivolume bar 504, 505 indicates whether the market is retesting a previous rotational high (e.g., when located at the bottom of the color-coded equivolume bar 504, 505) or low (e.g., when located at the top of the color-coded equivolume bar 504, 505) within as many ticks as the trader selected to accommodate a particular market's personality and timeframe.

In one embodiment, a trader employs a combination of market edge indicators 514-526 to identify trade opportunities. For example, a “B” indicator 516 with a blue deceleration indicator 522 and a rotational high indicator 518 signals a buying trend. Similarly, an “S” indicator 514 with a red deceleration square 524 and a rotational low indicator 520 further signals a selling trend. A combination of a rotational high or low indicator 518, 520, a deceleration indicator 522, 524, and a green retest circle 526 signals an edge trade in either direction.

Preferably, the trading interface 101 accepts user input for adjusting the market analysis studies corresponding to the real-time market edge indicators 514-526 to fit the user's timeframe (e.g., by accepting user input for specifying time increments along the time axes of the screens 400, 500, 501) and trade sensitivity, thereby increasing or decreasing the number of trades to be considered. The market studies are performed in real-time, allowing the trader to take a trade in the signal bar, or after the bar closes. The real-time feature improves trade location over time and serves as a way to get within a tick of the actual high or low of a rotation. Preferably, the real-time market studies corresponding to the market edge indicators 514-526 collect and organize raw data, or what is actually happening in the market, and then perform mathematical analysis.

Hence, the computer executable instructions underlying the trading interface 101 analyze those things that count in a trade and signal the trader when conditions are right to execute the trade. The trading interface 101 allows integration of multiple timeframes and market studies that bring a trader to the buy, sell or flat decision. Once the trader's analysis of the market profiles is complete and when the market conditions are ripe, the trader executes the trade directly from the screen 500 of the trading interface 101, such as via a “Trading” menu 528 (FIG. 5A).

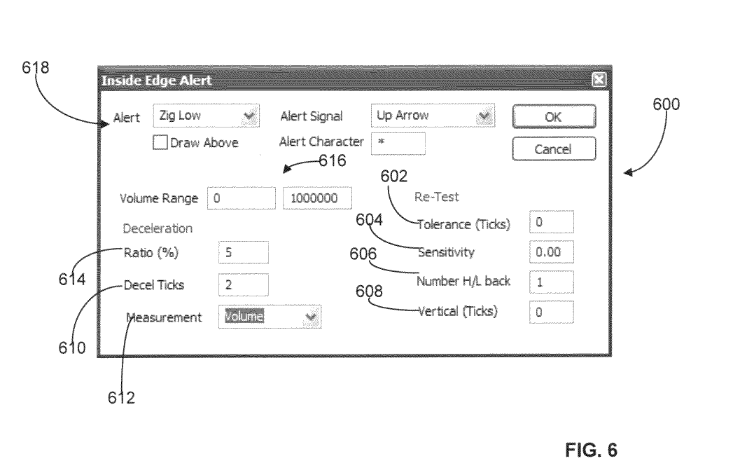

In order to customize the real-time market edge indicators 514-526, the trading interface 101 collects real time market data, such as trades (ticks), price, price changes, volume, and time and passes them to an alert generating module (e.g., computer executable instructions stored on a computer readable medium at the user computer 100 and/or at the data center 118 of FIG. 1) that evaluates the parameters on a tick-by-tick basis as the market moves in real-time. As illustrated in FIG. 6, the trader supplies the user defined parameters for generation of real-time market edge indicators 514-526 via a parameter input screen, such as the market edge parameter screen 600. For example, the market edge indicators 526 indicating retesting of rotational highs and lows are generated based on user input of retest tolerance 602 (in number of ticks), sensitivity 604, number of highs/lows back 606 to be identified, and the number of vertical ticks 608 allowed between the highs/lows.

Furthermore, the deceleration market edge indicators 524 are generated based on user input of deceleration ticks 610, type of market data 612 to measure, and deceleration ratio or percentage 614. Deceleration measures the decrease in market activity between prices as a percentage or ratio. Deceleration ticks 610 comprise the number of consecutive price levels to use for the computation of deceleration. The trader specifies the type market data 612 to measure for the generation of deceleration indicators 524. For example, measured market data may include volume, bid volume, ask volume, ticks, bid ticks, ask ticks, and price changes. When deceleration reaches a specified percentage 614, an alert generating module of the interface 101 generates a signal alerting the trader that conditions are conducive for a market turn around and/or a market pause.

The volume range parameters 616 are used to filter out volume bars outside the specified volume range to filter out market noise (i.e., low volume activity). Finally, the alert display customization area 618 accepts user input for customization of the manner and location in which the real-time market edge indicators 514-526 are displayed.

While the illustrated embodiments describe color-coding and use of characters and symbols of various shape, color, and size to represent volume, pricing (e.g., pricing at, above, or below value area), buying, selling, and market edge indicators, those of skill in the art will realize that alternate graphical representations are possible (e.g., various line types and/or graphical patterns) to present the trader with described market profile information via the trading interface 101 without departing from the spirit of the invention. Additionally, those of skill in the art will realize that at least some of the market profile information presented via the trading interface 101 may be combined between one or more interface screens 200, 300, 400, 500 or moved into one or more additional interface screens, such as when the trader wishes to decrease or increase the amount of market profile information presented on a given interface screen and sets up the trading interface 101 accordingly.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. In a computer system for identifying trade opportunities, a user interface for facilitating analysis of market data for a financial instrument and trade execution by a financial trader, the user interface comprising:
(a) a plurality of screens, each screen configured to display the market data along one of sequentially decreasing time axes;
(b) a plurality of vertically oriented price and volume distributions individually configurable by the financial trader to define a plurality of market profile splits, each market profile split comprising a plurality of timeframes corresponding to one of the sequentially decreasing time axes;
(c) a vertically oriented long-term volume distribution displayed within one or more of the plurality of screens, the vertically oriented long-term volume distribution comprising volume and price information for a plurality of months;
(d) an equivolume bar chart configured to display short-term price and volume information; and
(e) a plurality of market edge indicators for signaling changes in a trend of the market data, at least one of the market edge indicators corresponding to a potential trade opportunity.

2. The user interface of claim 1 wherein each of the plurality of market edge indicators is selected from the group consisting of: a rotational high indicator, a rotational low indicator, a retest of the rotational high indicator, a retest of the rotational low indicator, an acceleration indicator, a deceleration indicator, a sell trend indicator, and a buy trend indicator.

3. The user interface of claim 1 wherein at least one of the plurality of screens includes an interface for executing a trade.

4. The user interface of claim 1 wherein the equivolume bar chart comprises a plurality of bars, each bar graphically representing, along a horizontal axis, a trading volume of the financial instrument with respect to an average trading volume within the chart.

5. The user interface of claim 4 wherein each bar graphically represents, along a vertical axis, a price of the financial instrument.

6. The user interface of claim 4 wherein the equivolume bar chart is color-coded to represent trading volume corresponding to an offer volume and a bid volume for the financial instrument.

7. The user interface of claim 4 wherein the equivolume bar chart is color-coded to represent pricing with respect to a value area of the financial instrument.

8. The user interface of claim 4 wherein the equivolume bar chart is color-coded to represent trading volume mode and weighted mean of the trading volume of the financial instrument.

9. The user interface of claim 1 wherein the financial instrument is selected from the group consisting of: a futures contract, a stock, a bond, cash, cash equivalent, and an option.

10. A method for identifying trade opportunities, the method comprising:
collecting market data for a financial instrument;
displaying, via a user interface, the market data to facilitate analysis and trade execution by a financial trader, the user interface comprising:
(a) a plurality of screens, each screen configured to display the market data along one of sequentially decreasing time axes;
(b) a plurality of vertically oriented price and volume distributions individually configurable by the financial trader to define a plurality of market profile splits, each market profile split comprising a plurality of timeframes corresponding to one of the sequentially decreasing time axes;
(c) a vertically oriented long-term volume distribution displayed within one or more of the plurality of screens, the vertically oriented long-term volume distribution comprising volume and price information for a plurality of months;
(d) an equivolume bar chart configured to display short-term price and volume information; and
(e) a plurality of market edge indicators for signaling changes in a trend of the market data, at least one of the market edge indicators corresponding to a potential trade opportunity.

11. The method of claim 10 wherein each of the plurality of market edge indicators is selected from the group consisting of: a rotational high indicator, a rotational low indicator, a retest of the rotational high indicator, a retest of the rotational low indicator, an acceleration indicator, a deceleration indicator, a sell trend indicator, and a buy trend indicator.

12. The method of claim 10 further comprising receiving input for executing a trade from at least one of the plurality of screens.

13. The method of claim 10 wherein the equivolume bar chart comprises a plurality of bars, each bar graphically representing, along a horizontal axis, a trading volume of the financial instrument with respect to an average trading volume within the chart.

14. The method of claim 13 wherein each bar graphically represents, along a vertical axis, a price of the financial instrument.

15. The method of claim 13 wherein the equivolume bar chart is color-coded to represent trading volume corresponding to an offer volume and a bid volume for the financial instrument.

16. The method of claim 13 wherein the equivolume bar chart is color-coded to represent pricing with respect to a value area of the financial instrument.

17. The method of claim 13 wherein the equivolume bar chart is color-coded to represent trading volume mode and weighted mean of the trading volume of the financial instrument.

18. The method of claim 10 wherein the financial instrument is selected from the group consisting of: a futures contract, a stock, a bond, cash, cash equivalent, and an option.

19. A computer readable medium having stored thereon computer executable instructions for identifying trade opportunities, the instructions comprising:
collecting market data for a financial instrument;
displaying, via a user interface, the market data to facilitate analysis and trade execution by a financial trader, the user interface comprising:
(a) a plurality of screens, each screen configured to display the market data along one of sequentially decreasing time axes;
(b) a plurality of vertically oriented price and volume distributions individually configurable by the financial trader to define a plurality of market profile splits, each market profile split comprising a plurality of timeframes corresponding to one of the sequentially decreasing time axes;
(c) a vertically oriented long-term volume distribution displayed within one or more of the plurality of screens, the vertically oriented long-term volume distribution comprising volume and price information for a plurality of months;
(d) an equivolume bar chart configured to display short-term price and volume information; and
(e) a plurality of market edge indicators for signaling changes in a trend of the market data, at least one of the market edge indicators corresponding to a potential trade opportunity.

20. The computer readable medium of claim 19 wherein each of the plurality of market edge indicators is selected from the group consisting of: a rotational high indicator, a rotational low indicator, a retest of the rotational high indicator, a retest of the rotational low indicator, an acceleration indicator, a deceleration indicator, a sell trend indicator, and a buy trend indicator.
